(19) United States
(12) Patent Application Publication
(10) Pub. No.: US 2018/0023646 A1
(43) Pub. Date: Jan. 25, 2018

(54) Brake Application Mechanism of a Disc Brake

(71) Applicant: KNORR-BREMSE Systeme fuer Nutzfahrzeuge GmbH, Muenchen (DE)

(72) Inventors: Thomas BECK, Passau (DE); Michael HIDRINGER, Hofkirchen (DE); Wolfgang PRITZ, Muenchen (DE)

(21) Appl. No.: 15/693,909

(22) Filed: Sep. 1, 2017

Related U.S. Application Data
(63) Continuation of application No. PCT/EP2016/053700, filed on Feb. 23, 2016.

(30) Foreign Application Priority Data
Mar. 4, 2015 (DE) 10 2015 103 088.8

(51) Int. Cl. F16D 65/56; F16D 65/18

(52) U.S. Cl. CPC F16D 65/567; F16D 65/18; F16D 2200/0013; F16D 2250/0023; F16D 2250/0076; F16D 2121/14

(57) ABSTRACT

A brake application mechanism of a disc brake includes a pressure piece in contact with a brake pad, and a cylindrical threaded element that is retained on the pressure piece in such a way as to rotate therewith. The pressure piece and the threaded element that is connected thereto are designed as separate parts.

### CROSS REFERENCE TO RELATED APPLICATIONS

This application is a continuation of PCT International Application No. PCT/EP2016/053700, filed Feb. 23, 2016, which claims priority under 35 U.S.C. § 119 from German Patent Application No. 10 2015 103 088.8, filed Mar. 4, 2015, the entire disclosures of which are herein expressly incorporated by reference.

### BACKGROUND AND SUMMARY OF THE INVENTION

The invention relates to a brake application mechanism of a disc brake having a pressure piece which makes contact with a brake pad, and a cylindrical threaded element which is held in a rotationally fixed manner on the pressure piece.

A brake application mechanism of this type is known from DE 10 2006 010 754 A1. Said brake application mechanism has a centrally arranged, brake ram which can be pressed via a brake lever onto the brake application-side brake pad of a disc brake, with a threaded sleeve, onto which a pressure piece is integrally formed on its side which faces the brake pad, via which pressure piece the threaded sleeve is connected to the brake pad in a rotationally fixed manner.

In order to compensate for an air play, that is to say in order to compensate for a spacing between the brake pad and a brake disc, which spacing changes in a wear-induced manner, the threaded sleeve is mounted on an actuating spindle which is provided with an external thread and can be rotated by means of an adjusting device for air play compensation, that is to say for adjustment of the brake pad, with a simultaneous axial movement of the threaded sleeve.

In a brake application mechanism which is known from WO 2014/001 456 A1, the pressure piece and the threaded sleeve (which forms a threaded element in the sense of the generic type) are likewise configured in one piece, usually by way of casting. It is not taken into consideration here that different requirements are made of the pressure piece and the threaded sleeve, not least with regard to their different spatial shape.

Whereas the threaded sleeve is of substantially round cross section and is relatively long in relation to this, the pressure piece is flat and wide.

In addition to the absence of the possibility of meeting the different requirements made firstly of the pressure piece and secondly of the threaded sleeve with regard to the material selection, the known brake application mechanism also makes no contribution to the constant demand for weight optimization of all components of a commercial vehicle, the aim of which is a reduction in the fuel consumption and, as a consequence, in the CO2 emissions.

This is the case above all because, as has been mentioned, the single-piece configuration of the cylindrical threaded element/pressure piece unit is configured as a cast component, that is to say necessitates material thicknesses which are conditional on casting technology.

The invention is based on the object of developing a brake application mechanism of the generic type in such a way that it can be produced simpler and less expensively and is optimized in terms of material and weight with an identical load-bearing capacity.

This and other objects are achieved by way of a brake application mechanism having a pressure piece which makes contact with a brake pad, and a cylindrical threaded element which is held in a rotationally fixed manner on the pressure piece. The pressure piece and the threaded element which is connected to it are configured as separate components.

By virtue of the fact that, according to the invention, the pressure piece and the threaded element which is connected to it are configured as separate components, there is now the possibility of adapting each of the two components individually to the respective requirements, in particular with regard to their loading, both in relation to the dimensioning and in relation to the material to be used.

According to one preferred aspect of the invention, the threaded element is produced using the extrusion process with preforming of the outer and the inner geometry, with the result that only a little re-machining is required.

It is also contemplated, however, to produce the threaded element using other suitable forming or primary forming processes, such as cold extrusion or the like. The pressure piece in turn can be produced using the sand casting process or by way of forging. It goes without saying that other forming processes are also contemplated here, just like a material selection which is inspired by the requirements.

As a result, a reduction in the production costs is achieved overall, just like there is the option of a material mix of the structural unit which contributes to an optimization of the operability. This also otherwise applies to the geometries and dimensions of the involved components, which can be selected in accordance with the respective requirements.

A further advantage results from the targeted dimensioning which is then possible, in so far as the brake application mechanism can be produced with a reduced weight or an optimized weight as a result, which complies with the constant demands for this, as mentioned.

The connection of the threaded element to the pressure piece in such a way that both are held in a rotationally locked manner with respect to one another is likewise possible in different ways. These include a frictionally locking, integrally joined or positively locking connection.

Otherwise, no substantial preparation work is required for the integrally joined connection which is preferably produced by way of rotary friction welding which manages substantially without welding filler materials.

In addition, rotary friction welding is also suitable, in particular, for connecting different materials, iron metals such as steel and/or cast iron preferably being used here.

The very small heat affected zone which is produced during rotary friction welding is also particularly advantageous for the realization of the invention, since warping, in particular of the threaded element, by way of thermal stresses is substantially avoided.

It goes without saying that there is also the possibility of using other welding processes, for example fusion welding, said welding processes likewise being carried out in an automated manner like the rotary friction welding.

For a frictionally locking connection for connecting the two components to one another, corresponding receptacles for producing an interference fit are to be prepared.

Different measures are likewise contemplated for the positively locking connection, for example a screw connection, corresponding securing measures ensuring that said screw connection is not released automatically by way of the vibrations which occur during driving operation of the commercial vehicle. For instance, notches can be provided to this end, which achieve an anti-rotation safeguard.

Molded projections which correspond with one another can likewise be provided on the pressure piece and/or threaded element as positively locking elements which engage into one another, for example by being bent over, in such a way that both an axial movement safeguard and an anti-rotation safeguard are ensured.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a disc brake which is provided with a brake application mechanism according to the invention, in a sectioned plan view.

FIGS. 2A and 2B are views of a part of the brake application mechanism in different manufacturing steps, in each case in a perspective view.

### DETAILED DESCRIPTION OF THE DRAWINGS

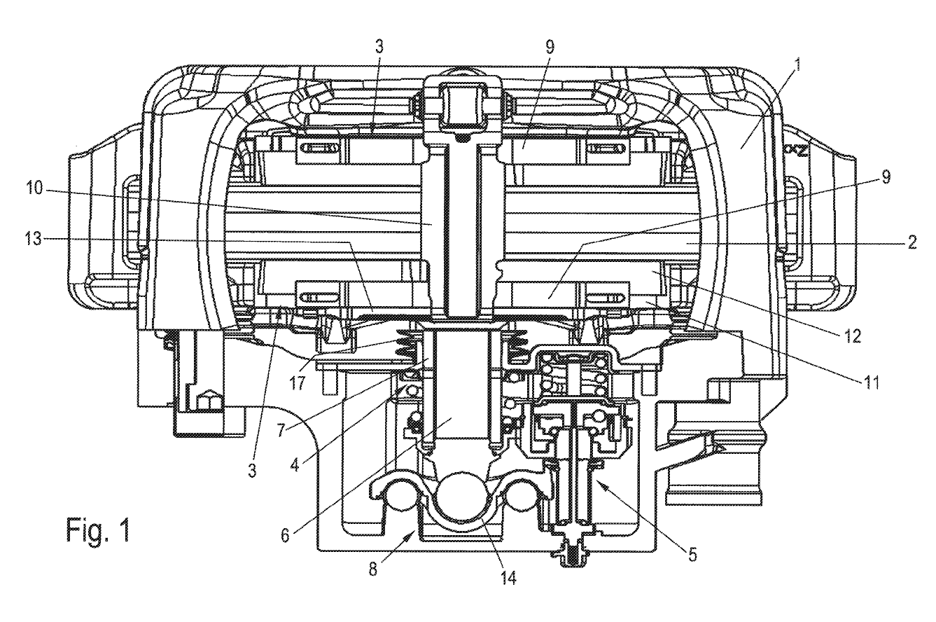

A diagrammatic illustration of a disc brake can be seen in FIG. 1, having a brake caliper 1 which engages over a brake disc 2, is configured as a sliding caliper, and in which two brake pads 3 are arranged which can be pressed against the brake disc 2 in the functional state, that is to say during a braking operation.

Here, first of all the brake application-side brake pad 3 is pressed against the brake disc 2 by means of a brake application mechanism 8, whereas subsequently, on account of the reaction forces, the reaction-side brake pad 3 is pressed against the brake disc 2 by way of the driving of the brake caliper 1 which is displaced.

Each brake pad 3 consists of a lining carrier plate 11 and a friction lining 12 which is fastened thereon and makes contact with the brake disc 2 during a braking operation.

In each case one pad holding spring 9 is fastened to the lining carrier plates 11, which pad holding springs 9, in interaction with a holding bracket 10, hold the brake pads 3 under prestress in a brake shaft of the brake caliper 1 or of a brake carrier.

The brake application mechanism 8 has a brake ram 4 which, arranged centrally, can be pressed against the brake application-side brake pad 3 in an axially displaceable manner via a brake lever 14.

Here, the brake ram 4 consists of an actuating spindle 6, to which an adjusting device 5 for compensating for an air play is connected, and a threaded sleeve 7 which engages with an internal thread into an external thread of the actuating spindle 6.

On its side which faces the lining carrier plate 11 of the brake application-side brake pad 3, the threaded spindle 7 is connected fixedly to a plate-shaped pressure piece 13 which bears against the lining carrier plate 11.

In order to prevent the threaded sleeve 7 and therefore the pressure piece 13 from corotating during a rotation of the actuating spindle 6 in order to compensate for the air play, said pressure piece 13 is held on the lining carrier plate 11 in a manner which is secured against rotation.

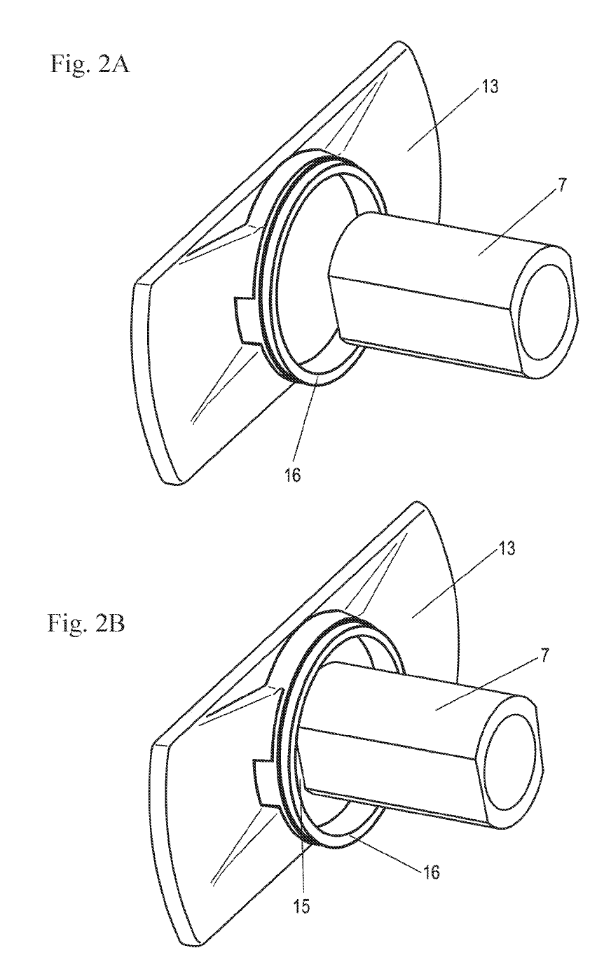

FIGS. 2A and 2B show, as a detail, the pressure piece 13 and the threaded sleeve 7 which forms a threaded element, which are configured as separate components according to the invention, as can be seen particularly clearly in FIG. 2A. A position is depicted here before the threaded sleeve 7 is connected fixedly to the pressure piece 13 by way of a suitable joining process. The threaded sleeve 7/pressure piece 13 structural unit is depicted in FIG. 2B in a connected arrangement, that is to say ready for use.

In the example, the threaded sleeve 7 is connected on the pressure piece 13 centrally by way of, for example, welding, such as rotary friction welding or fusion welding, identified by way of a welded seam 15.

Otherwise, an elevated ring 16 is integrally formed on the pressure piece 13 on the side which faces the threaded sleeve 7, concentrically with respect thereto, to which ring 16 a gaiter 17 which can be seen in FIG. 1 is connected in a functional state.

As has already been stated, other joining processes are also contemplated for connecting the threaded sleeve 7 and the pressure piece 13, in addition to the abovementioned integrally joined, frictionally locking or positively locking connection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake application mechanism of a disc brake, comprising:
a pressure piece which makes contact with a brake pad; and
a cylindrical threaded element which is held in a rotationally fixed manner on said pressure piece, wherein
the pressure piece and the threaded element that is connected thereto are configured as separate components.

2. The brake application mechanism as claimed in claim 1, wherein
the threaded element is configured as a threaded sleeve.

3. The brake application mechanism as claimed in claim 2, wherein
the pressure piece and the threaded element are connected fixedly to one another in an integrally joined, frictionally locking or positively locking manner.

4. The brake application mechanism as claimed in claim 1, wherein
the pressure piece and the threaded element are connected fixedly to one another in an integrally joined, frictionally locking or positively locking manner.

5. The brake application mechanism as claimed in claim 1, wherein
the threaded element is screwed to the pressure piece.

6. The brake application mechanism as claimed in claim 5, wherein
the screw connection is secured against rotation.

7. The brake application mechanism as claimed in claim 1, wherein
the pressure piece and the threaded element consist of different materials.

8. The brake application mechanism as claimed in claim 1, wherein
the pressure piece and the threaded element consist of different iron materials.

9. The brake application mechanism as claimed in claim 1, wherein
the threaded element and the pressure piece are connected to one another by way of rotary friction welding or fusion welding.

10. The brake application mechanism as claimed in claim 1, wherein
the pressure piece is formed from cast iron.

11. The brake application mechanism as claimed in claim 1, wherein
the threaded element is configured as an extruded part or a cold extruded part.

12. The brake application mechanism as claimed in claim 1, wherein
the pressure piece is configured as a forged part.
